(19) United States
(12) Patent Application Publication
(10) Pub. No.: US 2006/0265736 A1
(43) Pub. Date: Nov. 23, 2006

(54) Encryption system and method for legacy devices in a retail environment

(75) Inventors: Philip A. Robertson, Greensboro, NC (US); Rodger Karl Williams, Siler City, NC (US); Timothy M. Weston, Greensboro, NC (US)

Correspondence Address: WITHROW & TERRANOVA, P.L.L.C., P.O. BOX 1287, CARY, NC, 27512, US

(73) Assignee: GILBARCO INC., Greensboro, NC (US)

(21) Appl. No.: 11/132,967

(22) Filed: May 19, 2005

(51) Int. Cl. H04L 9/32

(52) U.S. Cl. 726/3

(57) ABSTRACT

A security module used in a retail establishment has two zones of operation. The first zone uses a first encryption scheme between data entry point devices, such as a PIN keypad and the security module. The second zone uses a second encryption scheme between the security module and the host network computer. Both the local encryption scheme and the host encryption scheme may be selectively and independently switched from a legacy encryption scheme to a new encryption scheme to accommodate evolving encryption requirements.

### FIELD OF THE INVENTION

The present invention relates to an encryption system associated with a retail environment, and particularly to an encryption device that is readily usable with legacy equipment and with next generation point of sale terminals in a retail environment.

### BACKGROUND OF THE INVENTION

Credit card companies such as VISA® and MASTERCARD® have been very successful in persuading consumers that credit cards should be used to complete any and all commercial transactions in place of cash. As a result of the success of the credit card, almost every retail establishment now has a magnetic card stripe reader. Concurrent with the proliferation of the magnetic stripe card readers used to process credit cards, many financial institutions have authorized the issuance of debit cards that are interoperable with the ubiquitous magnetic card readers.

Typically, a credit card is swiped through the magnetic card reader, and the credit card owner does not have to take further steps to complete the authorization of the transaction, although some establishments require a signature to complete the transaction. In contrast, a debit card typically requires the card owner to enter, via a keypad, a personal identification number (PIN) to complete customer authorization of the transaction since funds are transferred directly from the customer's bank account. In either case, the card number and the PIN (if present) are typically encrypted at the point of entry and then sent in an encrypted format over open communications links, such as a telephone line, to a host computer for transaction authorization. In some embodiments, the card number is not always encrypted. The encryption is used to protect the PIN and/or the card number from disclosure so that unauthorized persons may not eavesdrop and obtain the PIN in clear form and thus be able to use the PIN in conjunction with the card number to defraud the legitimate card holder, the vendor, or an authorizing institution or card issuer.

Commonly owned U.S. Pat. No. 5,228,084, which is hereby incorporated by reference in its entirety, describes the encryption process and teaches a fueling environment where a plurality of fuel dispensers can accept debit cards and PIN entry. The fueling environment is divided into two zones. The first zone is a local zone within the fueling environment. The local zone extends from the data entry point to a security module associated with a site controller. The second zone is the host zone and extends from the security module to the host computer that authorizes the transaction. The PIN and card number are encrypted by the data entry point device (a keypad, a card reader, or the like) using a local encryption algorithm, and are sent to the security module. The security module decrypts the information from the data entry point device using the local encryption scheme and re-encrypts the information according to a host encryption algorithm used by the host computer. After re-encryption, the information is sent to the host computer for transaction authorization. In this manner, the data entry points do not have to have access to the host encryption scheme. Thus, if the encryption scheme is changed at the host, the data entry points do not have to be replaced since they use a local scheme independent of the host scheme. Only the single security module in the fueling environment need be replaced with one security module having the new host scheme. Further, the likelihood of preserving the integrity of the host encryption scheme is increased because the opportunities for it to be compromised are reduced.

The products based on the '084 patent have proven reliable since their introduction. Recently, however, Card Issuers including VISA® and MASTERCARD® have announced a new requirement for encryption of data entered at the keypad with which compliance must be had to interact with the authorization system as a certified Payment Card Industry PIN Entry Device (PCI PED). Specifically, PCI PED requires encryption of data, including PIN data for debit cards, at the keypad, with a triple Data Encryption Standard (3DES). This change will force both host systems and retail establishments to upgrade to the new standards. In the interim, there will be many establishments both at the retail level and at the host network level that will employ legacy equipment that relies on the older encryption routines that have already been deployed. The potential combination of legacy and new equipment may make it difficult for the retail establishment to send the card information and PIN to the host network, and requires a novel solution. Additionally, the Payment Card Industry's movement to a new encryption standard may cause other companies such as DISCOVER® and AMERICAN EXPRESS® to move from legacy encryption schemes to new encryption schemes with similar concerns.

### SUMMARY OF THE INVENTION

The present invention allows legacy and new encryption mechanisms to interoperate within a retail establishment, and particularly a fueling environment, where there is a plurality of PIN entry devices. In particular, the present invention provides a security module that has two zones of encryption: a local zone and a host zone. Each zone's encryption scheme may be separately switched between a legacy mode and a new mode. By providing the switchable encryption schemes, the retail establishment can continue to operate under legacy encryption to the host in the event the host is not yet upgraded to the new scheme, but yet allow for the security module to switch to the new security scheme on the host zone when desired or ready and vice versa.

In an exemplary embodiment, the security module of the present invention may be installed in an existing retail establishment that has legacy data entry point devices. The local zone of the security module is set to a legacy encryption scheme. Likewise, the host network may use a legacy encryption scheme. The host zone of the security module is set to a legacy encryption scheme. At some future point, the retail establishment may upgrade its data entry point devices. At that time, the local zone of the security module is switched to the new encryption scheme. When the host network switches to the new encryption scheme, the host zone of the security module may be switched to the new encryption scheme. Without this switching functionality, the security module would have to be replaced when the retail establishment upgraded its data entry point devices and again when the host network upgraded its encryption system, resulting in unnecessary expense and inconvenience.

In a particularly contemplated embodiment, the security module is designed to work in a fueling environment wherein the data entry point devices are keypads or smart pads on fuel dispensers. In another particularly contemplated embodiment, the new encryption scheme is a 3DES encryption scheme and the legacy encryption schemes are Rivest-Shamir-Adelman algorithm (RSA), the Diffie-Hellman algorithm (DH), Data Encryption Standard (DES), or the like.

To effectuate the switch between the legacy encryption scheme and the new encryption scheme, the security module may be adapted to receive a signal that causes the switch. The signal may be provided electronically from a number of sources. For example, the signal may be generated within the factory during manufacturing, from a laptop connected to the security module, or from a point of sale (POS) or site controller device that is connected to the security module. The POS or site controller may generate the signal at the instruction of a maintenance or installation operator or from an instruction received from a remote location, such as through an internet connection or dial up connection to the POS or site controller.

In a particularly contemplated embodiment, once the switch is made to the new encryption scheme, the security module precludes switching back to the legacy encryption scheme.

Those skilled in the art will appreciate the scope of the present invention and realize additional aspects thereof after reading the following detailed description of the preferred embodiments in association with the accompanying drawing figures.

### BRIEF DESCRIPTION OF THE DRAWINGS

The accompanying drawing figures incorporated in and forming a part of this specification illustrate several aspects of the invention, and together with the description serve to explain the principles of the invention.

FIG. 1 illustrates a security module according to one embodiment of the present invention in a fueling environment;

FIG. 2 illustrates in a flow chart format the key generation between the security module and the fuel dispensers of the present invention;

FIG. 3 illustrates a variety of communication techniques which may be used to control the security module of the present invention;

FIG. 4 illustrates in tabular form the various possible states of the exemplary security module; and

FIG. 5 illustrates a flow chart of an exemplary life cycle of the security module of the present invention.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

The present invention allows legacy and new encryption mechanisms to interoperate within a retail establishment. In particular, the present invention provides a security module that has two zones of encryption: a local zone and a host zone. Each zone's encryption scheme may be separately switched between a legacy mode and a new mode. By providing the switchable encryption schemes, the retail establishment can continue to operate under legacy encryption to the host in the event the host is not yet upgraded to the new scheme, but yet allow for the security module to switch to the new security scheme on the host zone when desired or ready. Without this switching functionality, the security module would have to be replaced when the retail establishment upgraded its data entry point devices, and again when the host network upgraded its encryption system.

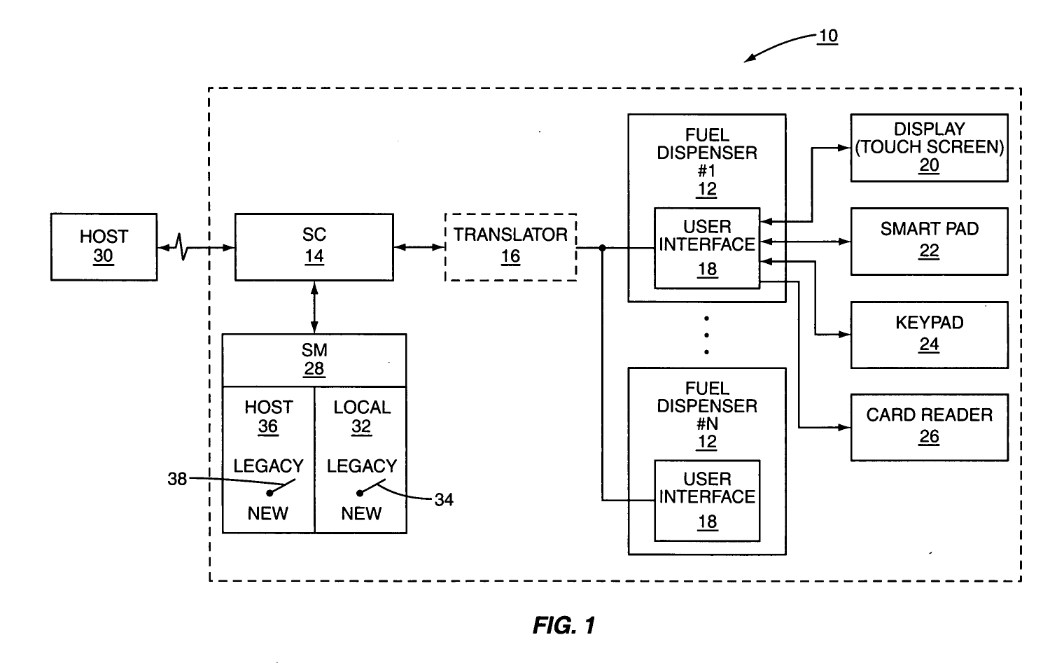

While the present invention is suited for use in a number of different retail establishments, a particularly contemplated embodiment is in a retail fueling environment 10, illustrated in FIG. 1. The retail fueling environment 10 includes N fuel dispensers 12 connected to a site controller (SC) 14. The connection between the fuel dispensers 12 and the site controller 14 may be facilitated through an optional translator 16. In an exemplary embodiment, the fuel dispensers 12 may be the ENCORE® or ECLIPSE® fuel dispensers sold by the assignee of the present invention, Gilbarco Inc., of 7300 W. Friendly Avenue, Greensboro, N.C. 22087. Other fuel dispensers could also be used if needed or desired. The site controller 14 may be the G-SITE® also sold by the assignee of the present invention, Gilbarco Inc. Other site controllers could also be used if needed or desired. Sometimes the site controller 14 may not be made by the same manufacturer as the fuel dispensers 12 in which case, certain proprietary protocols may not be fully compatible. The optional translator 16 may be used to make the elements compatible, as is well known.

Each fuel dispenser 12 may have a user interface 18. Each user interface 18 may include a display 20, which may optionally be a touch screen display, a smart pad 22, a keypad 24 and a card reader 26. For more information about the smart pad 22, the interested reader is referred to commonly owned U.S. Pat. No. 6,736,313, which is hereby incorporated by reference in its entirety. In use, the customer may swipe her debit card in the card reader 26 and enter her personal identification number (PIN) through either the smart pad 22 or the keypad 24. Collectively, the display 20 (if equipped with a touch pad), smart pad 22, the keypad 24, and the card reader 26 are referred to as data entry point devices. The user interface 18 encrypts the card number and the PIN according to a local encryption scheme and sends the encrypted information to a security module (SM) 28. The previously incorporated '084 and '313 patents both discuss how the card number and PIN are encrypted, and the interested reader is referred to those disclosures for a better comprehension of this process. The encrypted information is sent to the security module 28 through the site controller 14. Encryption of the information reduces concerns about sending the information over communication media on which the information may be intercepted.

The encrypted information is decrypted by the security module 28 using the local zone's encryption scheme and re-encrypted using a host encryption scheme. The security module 28 then sends the re-encrypted information to a host computer 30. The transmission to the host computer 30 may be over a telephone line, a packet network or the like. Even if the re-encrypted information is intercepted, the host encryption scheme reduces the likelihood of a malefactor gaining access to the card number or PIN. In an exemplary embodiment, the host computer 30 may be a front end merchant processor such as BUYPASS™, PAYMENTECH™, VITAL™, HEARTLAND EXCHANGE™, or the like. Front end merchant processors act as an interface to companies such as SUN TRUST™, BANK OF AMERICA™, WELLS FARGO™, CONCORD EFS™, and the like. Such arrangements are well known in the industry.

In prior systems, the local encryption scheme and the host encryption scheme did not need to be the same, and various vendors used various encryption schemes. When the vendor of the prior art security modules sold a security module, the purchaser specified which encryption scheme to use in the local zone and which encryption scheme to use in the host zone. Exemplary encryption schemes included, but were not limited to: pretty good privacy (PGP), Rivest-Shamir-Adelman (RSA), Data Encryption Standard (DES), and Diffie-Hellman (DH) algorithms. More information about the RSA and DH algorithms can be found in U.S. Pat. Nos. 4,405,829; 4,200,770; and 4,797,920, all of which are hereby incorporated by reference in the entirety. The specification of a particular encryption scheme was dictated in large part by encryption schemes used by the data entry point devices and the host network. During the manufacturing process, the security module was programmed or configured to support the specific encryption scheme. If the site operator changed host networks or changed data entry point devices such that a new encryption scheme was needed, the security module had to be replaced.

The present invention reduces the need for replacing the security module by its use of the security module 28 of the present invention. In an exemplary embodiment, the security module 28 has a local zone 32 in which two encryption schemes are selectively enabled. The first encryption scheme is a local legacy encryption scheme, and the second encryption scheme is a local new encryption scheme. A first switch 34 may be used to switch between the local legacy encryption scheme and the local new encryption scheme. This embodiment also has a host zone 36 in which two encryption schemes are selectively enabled. The first encryption scheme is a host legacy encryption scheme, and the second encryption scheme is a host new encryption scheme. A second switch 38 may be used to switch between the host legacy encryption scheme and the host new encryption scheme. The switches 34 and 38 may each be a physical switch, an electronic switch, or a software switch, as is better explained below.

The security module 28 is, in an exemplary embodiment, tamper-proof. More information on how to make the security module 28 tamper-proof can be found in the previously incorporated '084 patent. During manufacturing of the security module 28, the security module 28 may receive cryptographic keys for each encryption scheme (host and local, legacy and new). The cryptographic keys are, in an exemplary embodiment, stored in CMOS battery powered random access memory (RAM) chips located on a printed circuit board inside the security module 28. This arrangement is chosen so that the loss of power to the RAM quickly voids the sensitive data stored in the RAM. Other techniques such as “in chip non-volatile memory” or a device that encrypts memory automatically could also be used. As explained in the '084 patent, various techniques are used to prevent successful extraction of the keys from the security module 28.

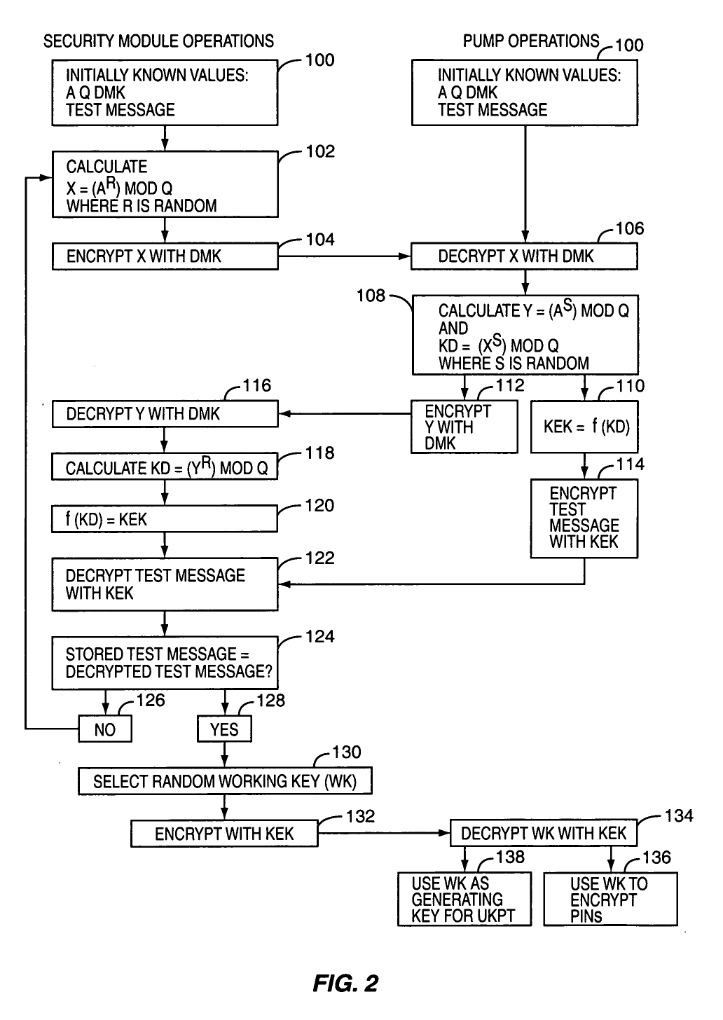

Once the security module 28 is installed at a retail establishment, such as the fueling environment 10, keys may be exchanged between the data entry point devices and the security module 28. In an exemplary embodiment, the site controller 14 is in overall charge of the operation of the fueling environment 10, including the sequence of events between the security module 28 and the fuel dispensers 12. The site controller 14, which is in communication with the fuel dispensers 12, determines that one or more of the fuel dispensers 12 requires a cryptographic key. To initiate the process, the site controller 14 requests key generation for a specific fuel dispenser 12 from the security module 28. The following process is known as exponential key exchange, and is presented in a flow chart format in FIG. 2. The security module 28 and the fuel dispenser 12 (or other remote unit as needed or desired) are both initially loaded with several values in common, namely the values A, Q, a test message, and a default master key (DMK) (blocks 100). The values A and Q are large prime numbers. None of these values need to be stored on a secure basis, since even knowledge of all four will not assist an interloper in determining the actual encryption keys which will be used to encrypt the PINs.

The security module 28 selects a large random number R and calculates the value X=Mod Q(A^{R}) (block 102), where the Mod function returns the integer remainder after long division. That is, X=the remainder when A to the R power is divided by Q. The value of X is then encrypted by the security module 28 using the default master key (block 104). The encrypted value of X is then sent to the site controller 14 and the site controller 14 sends it to the correct fuel dispenser 12. The fuel dispenser 12 decrypts X with the default master key (block 106). Then the fuel dispenser 12 selects a random number S and calculates Y=(A^{S}) Mod Q and K_{D}=(X^{S}) Mod Q (block 108)

The fuel dispenser 12 then calculates a Key Exchange Key (KEK) from the value KD (block 110). This calculation may involve any desired suitable function f(KD) so as to produce KEK as a 64 bit DES key. Several methods can be used in f(KD), including truncation and exclusive ORing parts of KD together.

The fuel dispenser 12 then encrypts Y with the default key (block 112), and encrypts the test message using the DES algorithm with KEK used as the encryption key (block 114). Both the encrypted Y and the encrypted test message are returned to the site controller 14 which in turn sends this data to the security module 28.

The security module 28 decrypts Y with the default key (block 116) and then calculates KD=(Y^{R}) Mod Q (block 118). The security module 28 then calculates KEK from the value KD, using the same function f(KD) previously used by the fuel dispenser 12 (block 120). Using the value KEK, the security module 28 then decrypts the test message which was encrypted by the fuel dispenser 12 with the KEK (block 122).

The security module 28 compares the stored test message to the decrypted test message (block 124). If the test message does not match the stored value (block 126), the security module 28 selects a new random number R, and calculates a new X=(A^{R}) Mod Q to start the process over again (block 102). If the decrypted test message matches the test message stored within the security module 28 (block 128), then the security module 28 continues with the setup process, because the fuel dispenser 12 and the security module 28 have calculated the same KEK. The KEK values in the fuel dispenser 12 and the security module 28 are equal, not only as confirmed by identity in the test messages, but also because the values of KEK calculated are mathematically equivalent.

The security module 28 then selects a randomly or pseudorandomly generated working key, WK (block 130), encrypts it with the KEK (block 132), and sends it to the site controller 14, which then sends it to the correct fuel dispenser 12. The fuel dispenser 12 decrypts the working key with the KEK (block 134). Depending on the desired mode of operation, the dispenser may use WK as an encrypting key in any of the various encryption methods whenever a PIN or card number is to be encrypted (block 136).

In a particularly contemplated embodiment, the fuel dispensers 12 use WK as a generating key for Unique Key Per Transaction (UKPT) (block 138). As long as the fuel dispenser 12 and the security module 28 retain the KEK, it is not changed, but the working keys between the security module 28 and the fuel dispensers 12 are preferably changed regularly in response to specific system events or on a timed basis. The KEKs may change for various reasons: cold starting a fuel dispenser 12 (clearing all its memory data storage); replacing a fuel dispenser 12 or a security module 28; or replacing a site controller 14 (either hardware or software). The generation of the KEKs may also be accomplished by algorithms other than exponential key exchange if needed or desired.

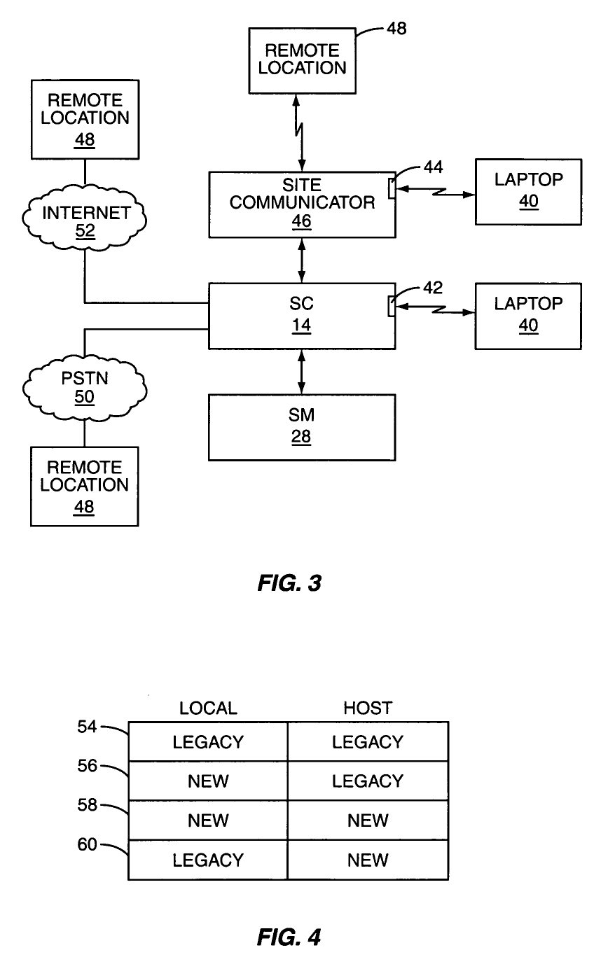

One of the benefits of the present invention is in the ability of the security module 28 to switch between encryption schemes. In particular, as illustrated in FIG. 3, the security module 28 may accept inputs from a number of different authorized sources that cause the security module 28 to change from the legacy encryption scheme to a new encryption scheme, such as 3DES. The following embodiments are not mutually exclusive, but it should be appreciated that only one technique is likely to be used at a time to change the operational encryption scheme. A laptop 40 with appropriate authorization indicia stored thereon may communicate with the security module 28 and cause the security module 28 to switch operational encryption schemes. In a first embodiment, the laptop 40 may be plugged into a port 42 on the site controller 14 and communicate through the site controller 14 to the security module 28. In a second embodiment, the laptop 40 may be connected to a port 44 on a site communicator 46 such as the SMART CONNECT™ sold by Gilbarco Inc. For more information about the SMART CONNECT™, reference is made to the product information found at http://www.gilbarco.com/pdfs/P2332.pdf and http://www.gilbarco.com/ind_product.cfm?ContentItemID=185, copies of which are filed with the application as part of the Information Disclosure Statement. In this embodiment, the laptop 40 communicates through the site communicator 46 and the site controller 14 to the security module 28. In either case, the ports 42 and 44 may be serial, parallel, wireless, infrared, microwave, wirebased, or other sort of port as needed or desired.

Alternatively, the site communicator 46 may communicate with a remote location 48 over a wide area network (WAN), a modem, or the like. The remote location 48 may provide instructions to the site communicator 46 which are then passed through the site controller 14 to the security module 28.

As yet another embodiment, the site controller 14 may communicate to one or more remote locations 48 through a public switched telephone network (PSTN) 50, or through a packet based network 52 such as the Internet. The connection between the site controller 14 and the remote location 48 may be wirebased or wireless as needed or desired. The connection may be a dedicated connection, such as a dial up modem, or other arrangement as needed or desired. In an exemplary embodiment, the remote location 48 may go through an authorization routine, such as a login and password, to have access to the site controller 14 and/or the security module 28.

The laptop 40 and/or the remote location 48, once they have gone through an appropriate authorization routine, sends an instruction to one of the switches 34 or 38 to switch from a legacy mode to the new mode of encryption. In a particularly contemplated embodiment, once a switch 34 or 38 has switched to the new mode of encryption, the switch 34 or 38 cannot switch back to the legacy mode of operation. As noted above, the switches 34 and 38 may be electronic switches such as a transistor based switch, a software switch, or a mechanical switch such as one that is thrown by the movement of a piezoelectric element. Other switches are possible and within the scope of the present invention.

FIG. 4 presents, in tabular form, the various operational states of the security module 28. In a first operational state, denoted 54, the local zone 32 uses a legacy encryption scheme, and the host zone 36 also uses a legacy encryption scheme. This first operational state 54 would occur when the site operator installed a new security module 28, but was still using legacy style data entry point devices and also was using a host network that had not upgraded to a new encryption scheme yet.

A second operational state, denoted 56, has the local zone 32 using a new encryption scheme such as 3DES and the host zone 36 using a legacy encryption scheme. This second operational state 56 would occur when the site operator had upgraded the data entry point devices to a new encryption scheme (perhaps to comply with the requirements of PCI PED), but the host network had not yet upgraded to a new encryption scheme. This situation might occur if a fueling environment 10 went through a major upgrade and replaced all its fuel dispensers 12 and other operating equipment, but the host network had not yet upgraded.

A third operational state, denoted 58, has the local zone 32 using a new encryption scheme, and the host zone 36 also using a new encryption scheme. This third operational state 58 would occur when the fueling environment 10 had upgraded its data entry point devices to use the new encryption scheme and the host network had likewise been upgraded to use the new encryption scheme. It is to be expected that eventually, all fueling environments 10 will need to be in third operational state 58 to comply fully with the requirements set forth in PCI PED.

A fourth operational state, denoted 60, has the local zone 32 using a legacy encryption scheme, and the host zone 36 using a new encryption scheme. It is currently expected that this fourth operational state 60 is unlikely to occur, as fueling environments 10 are likely to upgrade the data entry point devices before the host network upgrades to the new encryption scheme, but merely because this situation is unlikely does not mean that this fourth operational state 60 is not possible and is considered to be part of the present invention.

Please note that while RSA, DH, DES, PGP, and similar encryption schemes are specifically contemplated as being legacy encryption schemes, and 3DES is particularly contemplated as being a new encryption scheme, the present invention is not so limited. Anytime an evolution in encryption algorithms is contemplated, the encryption algorithms prevalent prior to the change would be legacy encryption schemes, and the next generation would be considered new encryption schemes as those terms are used herein. Further, the same labels could be applied to a transition from two older encryption schemes. For example, if RSA were widely deployed and a host network or vendor was requiring the transition to DH, then in this example, RSA would be considered a legacy encryption scheme and DH would be the new encryption scheme. The present invention is not limited to the particular encryption scheme, but rather is directed to changing from an existing encryption scheme to a new encryption scheme.

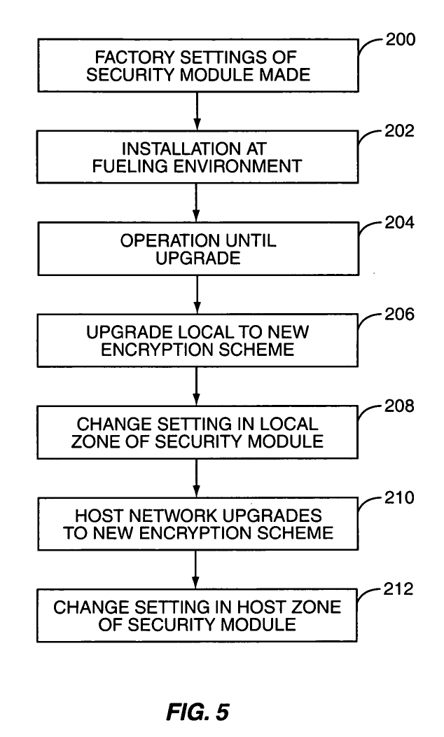

An exemplary life cycle of the security module 28 is presented in FIG. 5 in flow chart format. In this example, the fueling environment 10 has legacy equipment and is connected to a host network that has not moved to the next generation of encryption algorithms. The operator of the fueling environment 10 purchases a security module 28 according to the present invention, while indicating to the vendor what encryption modes are desired. The vendor generates the factory settings (block 200) for the legacy and new encryption schemes in the security module 28, and sets both switches 34 and 38 to legacy mode. The security module 28 is sent to the fueling environment 10 and installed at the fueling environment 10 (block 202). After installation, the keys are exchanged as noted above and operation in the local zone and host zone occurs using the respective legacy encryption schemes (block 204).

At some point, the fueling environment 10 replaces its data entry point devices. This upgrade may be as a result of replacing fuel dispensers 12 or other reason. In such an event, the new data entry point devices use the new encryption scheme (block 206), and are incompatible with the legacy encryption scheme used by the local zone 32 of the security module 28. The vendor logs into the site controller 14 and instructs the first switch 34 to move from the legacy encryption scheme to the new encryption scheme (block 208).

At some later date, the host network upgrades to the new encryption scheme (block 210). At that time, the security module 28 will not work if the host zone 36 remains set to the legacy encryption scheme. Thus, the vendor may log into the site controller 14 and instruct the second switch 38 to move from the legacy encryption scheme to the new encryption scheme (block 212).

Operation resumes as normal and the security module 28 functions using the new encryption scheme in both the local and host zones 32 and 36. Other life cycles are possible and within the scope of the present invention.

Those skilled in the art will recognize improvements and modifications to the preferred embodiments of the present invention. All such improvements and modifications are considered within the scope of the concepts disclosed herein and the claims that follow.

What is claimed is:

1. A security module for use in a network for securely communicating encrypted data from data entry point devices at a retail site to a host computer, the security module comprising:
a first zone having a first legacy encryption scheme and a first new encryption scheme, said first zone adapted to:
operate in the first legacy encryption scheme in a first mode and
operate in the first new encryption scheme in a second mode.

2. The security module of claim 1, further comprising a second zone having a second legacy encryption scheme and a second new encryption scheme, said second zone adapted to operate in the second legacy encryption scheme in a third mode and operate in the second new encryption scheme in a fourth mode.

3. The security module of claim 2, wherein the first zone comprises a host zone that connects the security module to the host computer and the second zone comprises a local zone that connects the security module to the data entry point devices at the retail site.

4. The security module of claim 2, wherein the retail site comprises a fueling environment and the data entry point devices comprises a device selected from the group consisting of: a keypad, a touchpad, a card reader, and a smart pad.

5. The security module of claim 1, wherein the first legacy encryption scheme is selected from the group consisting of: the Rivest-Shamir-Adelman algorithm (RSA), the Diffie-Hellman algorithm (DH), the Data Encryption Standard algorithm (DES), and some combination of RSA, DH, and DES.

6. The security module of claim 1, wherein the first new encryption scheme comprises a triple Data Encryption Standard algorithm (3DES).

7. The security module of claim 1, wherein the security module is adapted to receive an instruction switching from the first mode to the second mode.

8. The security module of claim 7, wherein the security module is adapted to receive the instruction from a remote location.

9. The security module of claim 7, wherein the security module is adapted to receive the instruction from a portable computing device.

10. The security module of claim 9, wherein the security module is adapted to send the instruction from the portable computing device through a site controller.

11. The security module of claim 9, wherein the security module is adapted to connect directly to the portable computing device.

12. The security module of claim 7, wherein the security module is adapted to receive the instruction through a communication network.

13. The security module of claim 7, wherein having received the instruction switching from the first mode to the second mode, the security module will no longer operate in the first mode.

14. A method of using an encryption device in a network for securely communicating encrypted data from a data entry point device at a retail site to a host computer, the method comprising:
separating the encryption device into a host zone and a local zone; and
switching from a legacy encryption scheme to a new encryption scheme in one of the host zone and local zone.

15. The method of claim 14, wherein switching from a legacy encryption scheme to a new encryption scheme in one of the host zone and local zone comprises switching from a first legacy encryption scheme to a first new encryption scheme in the host zone.

16. The method of claim 14, further comprising switching from a local legacy encryption scheme to a local new encryption scheme in the local zone.

17. The method of claim 14, further comprising connecting the host zone to the host computer and connecting the local zone to the data entry point device.

18. The method of claim 14, wherein the retail site comprises a fueling environment and the data entry point device comprises a device selected from the group consisting of: a keypad, a touchpad, a card reader, and a smart pad.

19. The method of claim 14, wherein switching from the legacy encryption scheme comprises switching from an encryption scheme selected from the group consisting of: the Rivest-Shamir-Adelman algorithm (RSA), the Diffie-Hellman algorithm (DH), the Data Encryption Standard algorithm (DES), and some combination of RSA, DH, and DES.

20. The method of claim 14, wherein switching from the legacy encryption scheme to the new encryption scheme comprises switching to a triple Data Encryption Standard algorithm (3DES).

21. The method of claim 14, further comprising generating an instruction that switches the encryption device from the legacy encryption scheme to the new encryption scheme.

22. The method of claim 21, wherein generating the instruction comprises generating the instruction in a remote location.

23. The method of claim 21, wherein generating the instruction comprises generating the instruction in a portable computing device.

24. The method of claim 23, further comprising passing the instruction from the portable computing device through a site controller.

25. The method of claim 23, further comprising connecting the portable computing device to the encryption device.

26. The method of claim 21, further comprising receiving the instruction through a communication network.

27. The method of claim 21, wherein having received the instruction switching from the first mode to the second mode, the encryption device will no longer operate in the first mode.

28. A fueling environment, comprising:
a plurality of fuel dispensers, each fuel dispenser comprising one or more data entry point devices, said one or more data entry point devices adapted to encrypt information input thereto according to a local encryption scheme; and
a security module, comprising:
a local zone communicatively coupled to the one or more data entry point devices and adapted to receive encrypted information therefrom and decrypt the encrypted information;
a host zone communicatively coupled to a host network, said host zone adapted to re-encrypt the information received from the one or more data entry point devices and send the re-encrypted information to the host network;
wherein one of the local and host zones comprises a legacy encryption mode and a new encryption mode and is selectively switched between the legacy encryption mode and the new encryption mode.

29. The fueling environment of claim 28, wherein the legacy encryption mode uses an encryption scheme selected from the group consisting of: the Rivest-Shamir-Adelman algorithm (RSA), the Diffie-Hellman algorithm (DH), the Data Encryption Standard algorithm (DES), and some combination of RSA, DH, and DES.

30. The fueling environment of claim 28, wherein the new encryption mode is a triple Data Encryption Standard (3DES) encryption scheme.

31. The fueling environment of claim 28, wherein the one or more data entry point devices is selected from the group consisting of: a keypad, a touchpad, a card reader, and a smart pad.

32. The fueling environment of claim 28, wherein the security module is adapted to receive an instruction switching from the first mode to the second mode.

33. The fueling environment of claim 32, wherein the security module is adapted to receive the instruction from a remote location.

34. The fueling environment of claim 32, wherein the security module is adapted to receive the instruction from a portable computing device.

35. The fueling environment of claim 34, wherein the security module is adapted to send the instruction from the portable computing device through a site controller.

36. The fueling environment of claim 34, wherein the security module is adapted to connect directly to the portable computing device.

37. The fueling environment of claim 32, wherein the security module is adapted to receive the instruction through a communication network.

38. The fueling environment of claim 32, wherein having received the instruction switching from the first mode to the second mode, the security module will no longer operate in the first mode.

39. A method of operating a fueling environment, comprising:
receiving data at one or more data entry point devices;
encrypting the data to form encrypted data at the one or more data entry point devices according to a local encryption scheme;
passing the encrypted data to a security module that decrypts the encrypted data;
re-encrypting the data at the security module with a host encryption scheme to form re-encrypted data;
sending the re-encrypted data to a host network;
selectively switching one of the local and host encryption schemes from a legacy encryption mode to a new encryption mode.

40. The method of claim 39, wherein the legacy encryption mode uses an encryption scheme selected from the group consisting of: the Rivest-Shamir-Adelman algorithm (RSA), the Diffie-Hellman algorithm (DH), the Data Encryption Standard algorithm (DES), and some combination of RSA, DH, and DES.

41. The method of claim 39, wherein the new encryption mode is a triple Data Encryption Standard (3DES) encryption scheme.

42. The method of claim 39 wherein receiving data at one or more data entry point devices comprises receiving data from a device selected from the group consisting of: a keypad, a touchpad, a card reader, and a smart pad.

43. The method of claim 39, further comprising receiving an instruction switching from the legacy encryption mode to the new encryption mode.

44. The method of claim 43, wherein receiving the instruction comprises receiving the instruction from a remote location.

45. The method of claim 43, wherein receiving the instruction comprises receiving the instruction from a portable computing device.

46. The method of claim 45, wherein receiving the instruction from the portable computing device comprises receiving the instruction through a site controller.

47. The method of claim 45 wherein receiving the instruction from the portable computing device comprises connecting the portable computing device directly to the security module.

48. The method of claim 43, wherein receiving the instruction comprises receiving the instruction through a communication network.

49. The method of claim 43, wherein having received the instruction switching from the legacy encryption mode to the new encryption mode, the security module will no longer operate in the first mode.

50. The method of claim 39, wherein selectively switching one of the local and host encryption schemes from the legacy encryption mode to the new encryption mode comprises switching the local encryption scheme.

51. The method of claim 39, wherein selectively switching one of the local and host encryption schemes from the legacy encryption mode to the new encryption mode comprises switching the host encryption scheme.
